(19) United States
(12) Patent Application Publication
(10) Pub. No.: US 2026/0370027 A1
(43) Pub. Date: Nov. 19, 2026

(54) CLAMPING ABRUPT HIGH SLEW RATE OVERSHOOTS WITH INTEGRATED ALTERNATING CURRENT CLAMP

(71) Applicant: Cirrus Logic International Semiconductor Ltd., Edinburgh (GB)

(72) Inventors: Rohit BUPATHY SUDAN, Austin, TX (US); Ravi K. KUMMARAGUNTLA, Austin, TX (US)

(73) Assignee: Cirrus Logic International Semiconductor Ltd., Edinburgh (GB)

(21) Appl. No.: 19/210,273

(22) Filed: May 16, 2025

(51) Int. Cl. H02J 7/96; H02J 7/64; H02J 7/94

(52) U.S. Cl. CPC H02J 7/96; H02J 7/64; H02J 7/94

(57) ABSTRACT

A battery management system may include a field-effect transistor (FET) coupled between an input and an output of the battery management system and an alternating current clamp coupled to the FET and configured to conditionally electrically clamp the input of the battery management system to ground in order to minimize electrical overshoot associated with an abrupt high-slew rate event within the battery management system.

### FIELD OF DISCLOSURE

The present disclosure relates in general to circuits for electronic devices, including without limitation personal audio devices such as wireless telephones and media players, and more specifically, systems and methods for providing protection in the event of an abrupt high-slew rate event, particularly an abrupt high-slew rate event involving a battery management system.

### BACKGROUND

Portable electronic devices, including wireless telephones, such as mobile/cellular telephones, tablets, cordless telephones, mp3 players, smart watches, health monitors, and other consumer devices, are in widespread use. Such a portable electronic device may include a battery (e.g., a lithium-ion battery) for powering components of the portable electronic device. Typically, such batteries used in portable electronic devices are rechargeable, such that when charging, the battery converts electrical energy into chemical energy which may later be converted back into electrical energy for powering components of the portable electronic device.

Such devices may include a battery management system, which may be implemented as a battery management integrated circuit (IC), for fuel gauging of a battery, battery charging of the battery, and/or power delivery to/from the battery. A battery management system may include a protection field-effect transistor (FET) which may be controlled within the battery management system to selectively couple/decouple a battery from a power source, as well as control current and/or voltage to the battery. In many instances, the protection FET may operate as at least a portion of an electronic fuse to protect circuits and components of a system from overcurrent, overvoltage, and other faults.

In a battery management system, an abrupt high-slew rate event (e.g., a hot plug event or hot plug-like event) may occur on an input to the battery management system, such as an event relating to a Universal Serial Bus (USB) adapter connector that couples the input of the battery management system to a power source. For example, in the case of a degraded USB connector cable, a “chatter” may occur which may open and close quicker than a shutdown of an adapter and effectively apply an abrupt high-slew rate event into the battery management system. In a worst-case scenario, such chattering could lead to application of a large voltage transient event to the system. With such event being a near-to-ideal step input, along with an adapter cable's underdamped network, and downstream capacitors on the output of the battery management system, the chattering may cause ringing and overshoots as high as two times the step input on the output of the battery management system. Further, in such situations, overcurrent may flow through the protection FET at levels high enough to damage the protection FET.

Accordingly, systems and methods for eliminating or minimizing such high-slew rate events may be desirable.

### SUMMARY

In accordance with the teachings of the present disclosure, one or more disadvantages and problems associated with existing approaches to managing overshoot in battery management systems may be reduced or eliminated.

In accordance with embodiments of the present disclosure, a battery management system may include a field-effect transistor (FET) coupled between an input and an output of the battery management system and an alternating current clamp coupled to the FET and configured to conditionally electrically clamp the input of the battery management system to ground in order to minimize electrical overshoot associated with an abrupt high-slew rate event within the battery management system.

In accordance with these and other embodiments of the present disclosure, a method may include, in a battery management system having a field-effect transistor (FET) coupled between an input and an output of the battery management system, conditionally electrically clamping, with an alternating current clamp coupled to the FET, the input of the battery management system to ground in order to minimize electrical overshoot associated with an abrupt high-slew rate event within the battery management system.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an example system for charging a battery, in accordance with embodiments of the present disclosure;

FIG. 2 illustrates selected components of an example battery management system, in accordance with embodiments of the present disclosure; and

FIG. 3 illustrates selected components of another example battery management system, in accordance with embodiments of the present disclosure.

### DETAILED DESCRIPTION

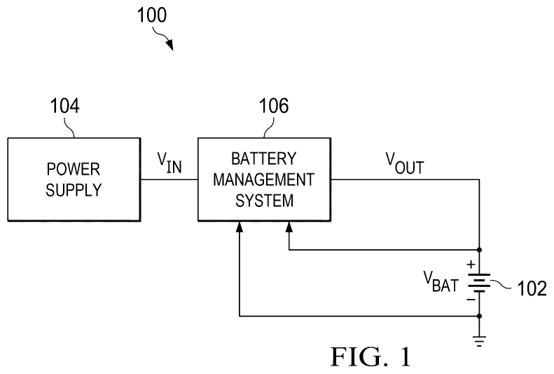

FIG. 1 illustrates an example system 100 for charging a battery 102, in accordance with embodiments of the present disclosure. As shown in FIG. 1, system 100 may include battery 102, a power supply 104, and a battery management system 106.

Battery 102 may include any system, device, or apparatus configured to convert chemical energy stored within battery 102 to electrical energy. For example, in some embodiments, battery 102 may be integral to a portable electronic device, and battery 102 may be configured to deliver electrical energy to components of such portable electronic device. Further, battery 102 may also be configured to recharge, in which it may convert electrical energy received by battery 102 into chemical energy to be stored for later conversion back into electrical energy. As an example, in some embodiments, battery 102 may comprise a lithium-ion battery.

Power supply 104 may include any system, device, or apparatus configured to supply electrical energy to battery management system 106. In some embodiments, power supply 104 may include a direct-current (DC) power source configured to deliver electrical energy at a substantially constant voltage. Accordingly, a peak-to-average power delivered from power supply 104 may be approximately equal to 1. In some of such embodiments, power supply 104 may include an alternating current (AC)-to-DC converter/adapter, configured to convert an AC voltage (e.g., provided by an electrical socket installed in the wall of a building) into a DC voltage.

Battery management system 106 may include any system, device, or apparatus configured to receive electrical energy from power supply 104 and/or battery 102, and control delivery of such energy to and/or from battery 102. In some embodiments, battery management system 106 may comprise a battery charger, configured to deliver electrical energy to battery 102 in order that battery 102 converts the electrical energy to chemical energy that is stored in battery 102. In some embodiments, battery management system 106 may include a wired charger configured to draw electrical energy from an electrical power outlet or from a power bank. In other embodiments, battery management system 106 may include a wireless charger configured to draw electrical energy via inductive coupling from a wireless charging pad or similar device. Battery management system 106 may be used for fuel gauging of a battery, battery charging of the battery, and/or power delivery to/from the battery.

In operation, battery management system 106 may monitor operating parameters associated with battery 102, including without limitation a current flowing to battery 102, voltages associated with battery 102, and/or other parameters, to control and/or monitor operation of battery 102.

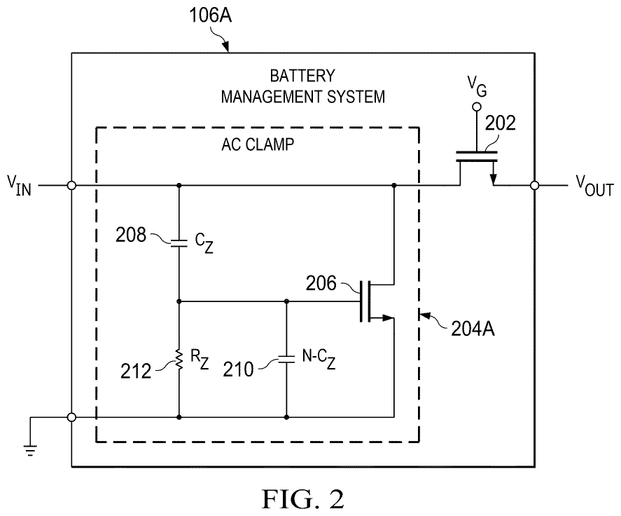

FIG. 2 illustrates selected components of a battery management system 106A, in accordance with embodiments of the present disclosure. Battery management system 106A may be used to implement battery management system 106 of FIG. 1. As shown in FIG. 2, battery management system 106 may include a protection field-effect transistor (FET) 202 and an alternating current (AC) clamp 204A.

Protection FET 202 may include any suitable transistor which may be activated (e.g., turned on, closed, enabled, etc.) and deactivated (e.g., turned off, opened, disabled, etc.) in response to a control signal (e.g., from a controller, such controller and control signal not explicitly shown on FIG. 1 for purposes of clarity and exposition). Although FIG. 2 depicts only a single protection FET 202 for the purposes of clarity and exposition, it is understood that battery management system 106 may include any suitable number of protection FETs 202.

AC clamp 204A may comprise any system, device, or apparatus configured to electrically clamp the input of battery management system 106A (e.g., the electrical node of input voltage V_{IN}) to ground in order to reduce overshoot. In particular, AC clamp 204A is shown implemented as an edge-triggered clamp (e.g., triggered by a rising edge of input voltage V_{IN}). In some embodiments, AC clamp 204A may include a clamping FET 206, and a resistive-capacitive network. Clamping FET 206 may be coupled at its non-gate (e.g., source and drain terminals) between the input of battery management system 106A and ground.

In the embodiment shown in FIG. 2, the resistive-capacitive network may include a capacitor 208 with capacitance C_{Z} coupled between the input of battery management system 106A and the gate terminal of clamping FET 206, a capacitor 210 with capacitance N·C_{Z} (e.g., N=3) between the gate terminal of clamping FET 206 and ground, and a resistor 212 with resistance R_{Z} in parallel with capacitor 210. Capacitances C_{Z} and N·C_{Z} and resistance R_{Z} may be selected to provide a desired trigger frequency and/or trigger voltage for turning on clamping FET 206 of AC clamp 204A. In some embodiments, one or more of capacitances C_{Z} and N·C_{Z}, resistance R_{Z}, and clamping transistor 206 may be tunable to a particular application. In some embodiments, the resistive-capacitive network may reside on the same integrated circuit as protection FET 202 (with tuning occurring within such integrated circuit). In other embodiments, the resistive-capacitive network may reside externally to integrated circuit housing protection FET 202 (with tuning occurring externally to such integrated circuit).

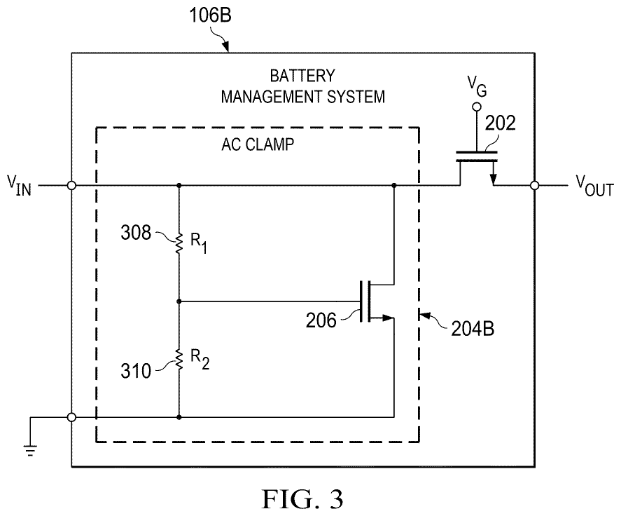

FIG. 3 illustrates selected components of a battery management system 106B, in accordance with embodiments of the present disclosure. Battery management system 106B may be used to implement battery management system 106 of FIG. 1. As shown in FIG. 3, battery management system 106 may include a protection FET 202 and an AC clamp 204B. Protection FET 202 of battery management system 106A may be similar or identical to protection FET 202 of battery management system 106B.

AC clamp 204B may comprise any system, device, or apparatus configured to electrically clamp the input of battery management system 106B (e.g., the electrical node of input voltage V_{IN}) to ground in order to reduce overshoot. In particular, AC clamp 204B is shown implemented as a level-triggered clamp (e.g., triggered by input voltage V_{IN} reaching a particular threshold voltage). In some embodiments, AC clamp 204B may include a clamping FET 206, and a resistor divider network. Clamping FET 206 may be coupled at its non-gate (e.g., source and drain terminals) between the input of battery management system 106 and ground.

In the embodiment shown in FIG. 3, the resistor divider network may include a resistor 308 with resistance R₁ coupled between the input of battery management system 106B and the gate terminal of clamping FET 206 and a resistor 310 with resistance R₂ coupled between the gate terminal of clamping FET 206 and ground. Resistances R₁ and R₂ may be selected to provide a trigger voltage for turning on clamping FET 206 of AC clamp 204B. In some embodiments, one or more of resistances R₁ and R₂ and clamping transistor 206 may be tunable to a particular application. In some embodiments, the resistor divider network may reside on the same integrated circuit as protection FET 202 (with tuning occurring within such integrated circuit). In other embodiments, the resistor divider network may reside externally to integrated circuit housing protection FET 202 (with tuning occurring externally to such integrated circuit).

In some embodiments, features of AC clamp 204A and AC clamp 204B may be combined, to provide for clamping that is both edge-triggered and level-triggered.

In these and other embodiments, clamping FET 206 may be implemented as part of a blocking FET of battery management system 106 in order to make it more effective and/or minimize its area.

In these and other embodiments, AC clamps 204A and 204B may be implemented to work in tandem with or independent from electrostatic discharge protection features. In some embodiments, whether implemented to work in tandem with or independent from electrostatic discharge protection may depend on the specific application.

In these and other embodiments, AC clamps 204A and 204B may be enabled or disabled using on-chip controls to implement protection of AC clamps 204A and 204B on an as-needed basis.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A battery management system comprising:
a field-effect transistor (FET) coupled between an input and an output of the battery management system; and
an alternating current clamp coupled to the FET and configured to conditionally electrically clamp the input of the battery management system to ground in order to minimize electrical overshoot associated with an abrupt high-slew rate event within the battery management system.

2. The battery management system of claim 1, wherein the alternating current clamp comprises a clamping transistor coupled between the input and ground.

3. The battery management system of claim 2, wherein the clamping transistor is implemented as part of a blocking FET of the battery management system.

4. The battery management system of claim 1, wherein the alternating current clamp comprises an edge-triggered clamp that triggers based on an edge of an input voltage present on the input.

5. The battery management system of claim 4, wherein the alternating current clamp comprises an electrical network tuned to provide one or both of a desired trigger frequency and a desired trigger voltage for activating the alternating current clamp.

6. The battery management system of claim 5, wherein the electrical network and the FET reside on a single integrated circuit.

7. The battery management system of claim 5, wherein the electrical network is located external to an integrated circuit comprising the FET residing on a single integrated circuit.

8. The battery management system of claim 1, wherein the alternating current clamp comprises a level-triggered clamp that triggers based on a level of a voltage present within the battery management system.

9. The battery management system of claim 8, wherein the alternating current clamp comprises an electrical network tuned to provide a desired trigger voltage for activating the alternating current clamp.

10. The battery management system of claim 9, wherein the electrical network and the FET reside on a single integrated circuit.

11. The battery management system of claim 9, wherein the electrical network is located external to an integrated circuit comprising the FET residing on a single integrated circuit.

12. The battery management system of claim 8, wherein the voltage is an input voltage present on the input.

13. The battery management system of claim 1, wherein the alternating current clamp comprises a level-triggered clamp that triggers based on a level of a current present within the battery management system.

14. The battery management system of claim 1, wherein the alternating current clamp comprises a level-triggered clamp that triggers based on a slew rate of level of a current or a voltage present within the battery management system.

15. The battery management system of claim 1, wherein the alternating current clamp is configured to work in tandem with electrostatic discharge protection features of the battery management system.

16. The battery management system of claim 1, wherein the alternating current clamp is configured to be selectively enabled or disabled on an as-needed basis.

17. The battery management system of claim 1, wherein the FET is used as the alternating current clamp.

18. A method comprising, in a battery management system having a field-effect transistor (FET) coupled between an input and an output of the battery management system:
conditionally electrically clamping, with an alternating current clamp coupled to the FET, the input of the battery management system to ground in order to minimize electrical overshoot associated with an abrupt high-slew rate event within the battery management system.

19. The method of claim 18, wherein the alternating current clamp comprises a clamping transistor coupled between the input and ground.

20. The method of claim 19, wherein the clamping transistor is implemented as part of a blocking FET of the battery management system.

21. The method of claim 18, wherein the alternating current clamp comprises an edge-triggered clamp that triggers based on an edge of an input voltage present on the input.

22. The method of claim 21, wherein the alternating current clamp comprises an electrical network tuned to provide one or both of a desired trigger frequency and a desired trigger voltage for activating the alternating current clamp.

23. The method of claim 22, wherein the electrical network and the FET reside on a single integrated circuit.

24. The method of claim 22, wherein the electrical network is located external to an integrated circuit comprising the FET residing on a single integrated circuit.

25. The method of claim 18, wherein the alternating current clamp comprises a level-triggered clamp that triggers based on a level of a voltage present within the battery management system.

26. The method of claim 25, wherein the alternating current clamp comprises an electrical network tuned to provide a desired trigger voltage for activating the alternating current clamp.

27. The method of claim 26, wherein the electrical network and the FET reside on a single integrated circuit.

28. The method of claim 26, wherein the electrical network is located external to an integrated circuit comprising the FET residing on a single integrated circuit.

29. The method of claim 25, wherein the voltage is an input voltage present on the input.

30. The method of claim 18, wherein the alternating current clamp comprises a level-triggered clamp that triggers based on a level of a current present within the battery management system.

31. The method of claim 18, wherein the alternating current clamp comprises a level-triggered clamp that triggers based on a slew rate of level of a current or a voltage present within the battery management system.

32. The method of claim 18, wherein the alternating current clamp is configured to work in tandem with electrostatic discharge protection features of the battery management system.

33. The method of claim 18, wherein the alternating current clamp is configured to be selectively enabled or disabled on an as-needed basis.

34. The method of claim 18, wherein the FET is used as the alternating current clamp.
